(19) United States
(12) Patent Application Publication
(10) Pub. No.: US 2002/0006787 A1
(43) Pub. Date: Jan. 17, 2002

(54) Pocket concierge and multimedia, wireless call center system and method

(76) Inventor: George Eugene Darby, Mililani, HI (US)

Correspondence Address: GEORGE E. DARBY, P.O. BOX 893010, MILILANI, HI, 96789-3010, US

(21) Appl. No.: 09/905,299

(22) Filed: Jul. 12, 2001

Related U.S. Application Data
(60) Provisional application No. 60/217,536, filed on Jul. 12, 2000.

(51) Int. Cl. H04M 3/00

(52) U.S. Cl. 455/419; 370/913

(57) ABSTRACT

The Pocket Concierge and Multimedia, Wireless Call Center Method and System, called herein the “Pocket Concierge service”, comprises three subsystems: an end-user subsystem, at least one call center subsystem, and one or more digital communications networks. A Pocket Concierge service operator provides various information and facilitation services to end-users.

### RELATED APPLICATIONS

This application claims the benefit of the provisional patent application, serial No. 60/217,536, filed on Jul. 12, 2000, in the U.S. Patent and Trademark Office for an invention entitled “Multimedia, Wireless Call Center Method and System”.

### BACKGROUND OF THE INVENTION

1. Field of the Invention

Call centers are equipped and staffed for the provision to end-users of information services, especially technical support and reservation services. End-users may be: retail consumers, employees of supply channel or distribution channel partners, consultants, internal staff, maintenance contract subscribers, travelers, etc.

Advanced call centers usually comprise: connectivity to public and private wide area networks, a call distribution system (either circuit switched or packet-switched, e.g., Voice over Internet Protocol, data call, instant message, etc.), a local area network, applications software, World Wide Web servers, database servers, application servers, workstations, wide area network connectivity, and personnel who operate workstations or “seats” in the call center.

A “helpdesk” is a call center that primarily provides technical information services. A “res center” is a call center that primarily provides reservation services.

2. Description of Related Art

Call center technology began with automatic call distributors, and is now well established as a means to view customer account information while speaking with the account holders concerning account matters. To date, call centers, other than those for mobile phone carriers, have relied only incidentally on end-user wireless devices, for instance, to page a technician to answer a trouble call, or to update the memory contents of a remote device. See, e.g., U.S. Pat. No. 6,249,771, granted to Kurihara. Multi-media call centers are uncommon, and to date only call center personnel have had multimedia service. See, e.g., U.S. Pat. No. 6,212,178, granted to Beck, et al. In short, multimedia services, combined with call center services, directed to wireless device users is terra incognita.

With the advent of multimedia, mobile “smart phones,” XML and HTML browsers for small, handheld computers and smart phones, and high speed data channels serving such computers and phones, multimedia, wireless call center services have become technically and economically feasible. In particular, the high-speed data services under Unified Mobile Telephone System (“UMTS”) protocols will soon provide the technological platform for multimedia, wireless call center services, but unsolved problems remain concerning how to architect such systems, what services to provide, and how such services should be provided from operational, and end-user interface, standpoints.

### SUMMARY OF THE INVENTION

The Pocket Concierge and Multimedia, Wireless Call Center Method and System, called herein the “Pocket Concierge service”, comprises three subsystems: an end-user subsystem, a call center subsystem, one or more digital communications networks. A Pocket Concierge service operator provides various information and facilitation services to end-users. The Pocket Concierge service is normally operated using points of sale and points of offer subsystems.

The end-user subsystem is a wireless digital telecommunications device (“Wireless Module”) closely interfaced with a mobile computing device (“Pocket Computer”), such as a pocket PC or other small computers. The end-user subsystem (the combination of the Wireless Module and the Pocket Computer) is called herein the “Pocket Part”. The Pocket Computer contains at least an XML/HTML browser, input/output interface to the Wireless Module, a display capability, a data entry capability, audiovisual (“multimedia”) capability, and the other normal parts of a computer (CPU, ROM, RAM, systems software, applications software), and optionally, removable storage, and additional interfaces.

The display component of the Pocket Computer normally includes a color, touch sensitive, LCD panel on the face of the Pocket Computer, but the display could be a goggle, tactile or skin pad, or other human interface output device interfaced with the Pocket Computer.

The data entry component of the Pocket Computer normally includes the touch sensitive LCD panel (“touch screen”) with a “soft keyboard”, handwriting recognition, and, optionally, voice recognition capability. The data entry component could be a touch sensitive device other than an LCD screen, or a motion sensitive device such as a video camera.

The audiovisual component of the Pocket Computer, in addition to the display component, normally includes a microphone, loudspeaker, earphone, and, optionally, a video camera. The microphone and earphone are normally combined in an earset (an ear mounted headphone and boom microphone). A handset can be used in lieu of an earset.

The Wireless Module is a base, insert, or jacket that mates with the Pocket Computer, or a smaller electronics module in PCMIA, Compact Flash II, and similar “removable” form factor. The Wireless Module can also be an internal module within a Pocket Computer, creating a type of “smart phone” or “very smart phone”. The Wireless Module provides voice, data, and audiovisual communications between the Pocket Computer and the call center subsystem using wireless communications technologies. The Wireless Module can operate on one or more RF bands and airlink standards. Where local wireless service is not available, orbital satellite services can be used with a satellite capable Wireless Module; satellite services data rates are slower than terrestrial wireless data rates, but are adequate for voice, Internet access, and relatively static graphics, such as maps.

The Compaq H3600 iPAQ series of Pocket Computers, available from Compaq Computer Corporation, 20555 SH 249, Houston, Tex. (www.compaq.com), is the first commercially available product that provides the minimum complement of features required for the Pocket Part. The Compaq H3600 Pocket PCs have: an XML/HTML browser; a color, 320×240 pixel, touch sensitive screen; input/output interface to a Wireless Module; data entry using soft keyboard (i.e., the end-user selects a given letter by touching the appropriate letter on a miniature keyboard displayed on the LCD screen), microphone, loudspeaker, and headphone jack. Wireless Modules for the H3600 uses various airlink standards, e.g., GSM, CDMA, and soon UMTS. Although Wireless Modules that use telephony airlink standards are described, other airlink standards could be used, e.g., cellular packet data, private radio, satellite. The Pocket Part normally includes a proximate area network interface (e.g., Bluetooth, IEEE 802.11, infrared) for local wireless communications. The Pocket Part can include a terrestrial network interface (dial-up modem, serial port, USB port, etc.) as failover or backup support if wireless access is not available.

The Pocket Part software applications support one or more of the following information services: voice calling, data calling, paging, audioconferencing, videoconferencing, sensor monitoring e.g., biological, environmental, video, personal security), location (based on geostationary positioning satellite (“GPS”), LORAN, VORTAC, etc.), remote sensing, remote diagnostics, reservations, entertainment, shopping/procurement, office, and vertical industry (sales force automation, engineering, construction, medical, manufacturing, extractive, etc.) services.

The call center subsystem, hereinafter called the “Call Center,” uses commercially available call center components, e.g., connectivity to one or more public and private wide area networks (including satellite, fiberoptic, and the wireless network used by an end-user subsystem), a circuit-switched call distribution system, a packet-switched (e.g., Voice over Internet Protocol, data call, instant message, etc.) call distribution system, a local area network, applications software, World Wide Web servers, database servers, application servers, and workstations. The Call Center supporting the wireless connection to a Pocket Part is called the “serving Call Center”.

The digital communications network subsystem uses commercially available wireline and wireless digital networks, hereinafter called the “Networks.” A terrestrial or satellite wireless network is used to reach the Pocket Parts. Wireline and/or wireless networks interconnect the Call Center with network, human, or institutional resources required to respond to end-user requests. The advent of national wireless providers with flat rate calling plans and high-speed data service using existing airlink standards, such as CDMA, enables Pocket Concierge service to be national in scope (or international, where international roaming agreements, the same airlink standard, and multi-band Wireless Modules are available). With the deployment of UMTS, international Pocket Concierge service will become easier to implement. UMTS terrestrial service data rates range from 384 Kbps to over 2 Mbps, which are more than adequate to support wireless multimedia, including videoconferencing and digital television. The Pocket Concierge service is normally operated using points of sale and points of offer subsystems. If points of sale and points of offer are used, the Wireless Module and the points of sale and points of offer exchange wireless messages using a proximate area network technology.

### BRIEF DESCRIPTION OF THE DRAWINGS

FIG. 1 illustrates the basic components of the Pocket Concierge service.

### DETAILED DESCRIPTION OF THE PREFERRED EMBODIMENTS

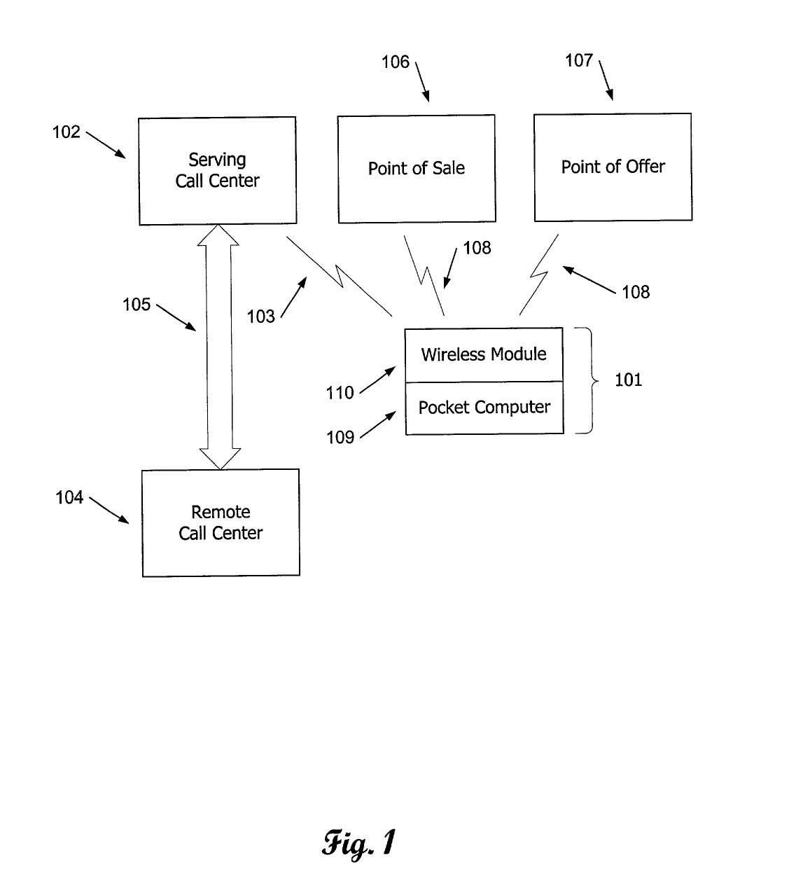

As shown in FIG. 1, the Pocket Concierge and Multimedia, Wireless Call Center System and Method invention comprises is a Pocket Part (101), a serving Call Center (102), and a wireless link (103). One or more remote Call Centers (104) connected to the serving Call Center by a Network (105), and one or more optional Points of Sale (106) and Points of Offer (107) connected to the Pocket Part (101) by proximate area network links (108), are used in the preferred embodiment. A Pocket Part comprises a Pocket Computer (109) and a Wireless Module (110). The Pocket Computer (109) contains at least an XML/HTML browser, input/output interface to the Wireless Module, a display capability, a data entry capability, audiovisual (“multimedia”) capability, and the other normal parts of a computer (CPU, ROM, RAM, systems software, applications software), and optionally, removable storage, and additional interfaces. The Wireless Module (110) contains at least an input/output interface to the Pocket Computer, a wireless transceiver for the wireless link (103), and an optional proximate area network transceiver for the proximate area network links (108). The serving Call Center has connectivity to wireless links (103) and to the Network (105). The Pocket Concierge service is normally operated using points of sale and points of offer subsystems. If points of sale and points of offer are used, the Wireless Module and the points of sale and points of offer exchange wireless messages using a proximate area network technology and contain proximate area network transceivers.

The multimedia component of the Pocket Concierge service depends upon high data rate wireless services. UMTS holds particular promise for full-time connectivity of the Pocket Part, with instant availability of high data rates. UMTS data services can be priced by the packet instead of by the minute. For instance, in telemedicine and telesecurity applications, the call center subsystem can maintain full-time contact with a Pocket Part. Transmission costs are incurred only when defined events occur that require that a message be sent from the Pocket Part, such as departure from or entry into a secure area in a telesecurity application, or low blood pressure in a telemedicine application.

In addition to the novelty in the combination of the elements described above in the Summary of the Invention section, additional inventive steps in the Pocket Concierge are as follows:

End-user Security Features.

Pocket Concierge service improves the safety or confidence of persons exposed to risk or lack of information. For an end-user exposed to medical risk, the Pocket Part can monitor vital signs, air quality, water quality, etc., and alert a Call Center of any deterioration in medical or environmental condition. For an end-user exposed to physical risk, the Pocket Part can monitor the audio and video environment of the end-user, vital signs, sensors (dosimeters, impact sensors, etc.), and dispatch assistance if a threat is detected by monitoring or if assistance is requested by the end-user. If full-time transmission of audio and video is not warranted, a request for assistance or a need to confirm the status of the end-user can be inferred if the end-user fails to respond when polled by a Call Center, or if sensor readings (impact, ambient oxygen levels, etc.) exceed or fall below threshold levels. If an end-user does request assistance, Call Center personnel or a software agent can alert or conference in the appropriate dispatch service (fire, police, ambulance, Coast Guard, search and rescue, etc.), and provide language translation as needed. In another area of physical security, Pocket Parts equipped with optional tactile pad outputs (for navigation data output) could be used by sight-impaired persons to navigate, especially in unfamiliar areas. A Pocket Part can be interfaced with building security systems, e.g., a residential security system, to avoid loss of contact by a building security system with a security services call center if the wireline connection to the building is interrupted, e.g., cut by a burglar.

The Pocket Part can provide interactive navigation for pedestrians and drivers. In an automotive embodiment, the Pocket Part can be used in conjunction with a an optional video output and external video display (e.g., LCD panel) visible to the driver. A button or menu selection on Pocket Part can be dedicated to presenting an instant display of the location of the end-user and/or of the destination or other points of interest. Location detection can be based on wireless triangulation (wireless carrier, proximate area network, or GPS). Location detection can also be provided by points of offer and points of sale, as defined below, whenever an end-user passes within range of a point of sale or point of sale transceiver.

Pocket Part Asset Management.

The Pocket Part is small, highly portable, and moderately expensive (approximately $600 in basic configuration, assuming a $150 Wireless Module and a $450 Pocket Computer). Loss of Pocket Parts through theft or misplacement is a very real risk to a Pocket Concierge service operator. To deter theft and to enhance recovery of Pocket Parts, the Pocket Computer and Wireless Module, if manufactured as separate units, are tightly bonded with fasteners or adhesives so that separation without the proper tools or solvents would result in destruction of the Pocket Part. A Pocket Part inventory tracking program resident on a “Pocket Part asset management server” interfaced with a Call Center can periodically poll the location of each Pocket Part managed by that Call Center to ensure compliance with any geographic limits of permitted use of the Pocket Part. If geographic limits are exceeded, the Pocket Part can be disabled except for emergency services, or the end-user can be surcharged for a wider geographic operating area. The determination of the location of a Pocket Part is by RF triangulation, RF proximity detection, transaction history (as described below), and other methods known in the art. Within each Pocket Part is an optional emergency battery that initiates a location report even if the main battery of the Pocket Part is fully depleted, similar to the use of an Emergency Locator Transmitter in aircraft. In the event the emergency battery dies, and thereafter the Pocket Part is recharged and connected to a network, within each Pocket Part is a firmware application that reports the location of the Pocket Part (without informing the end-user of the transmission of such tracking messages), even outside the original Pocket Part service area; if wireless service is available, the report is made by wireless connectivity to any terrestrial or satellite wireless service available for such purposes; the report is normally made by Internet email, datagram, or a dialup call to the Pocket Part asset management server. As a further precaution, the Pocket Part can optionally remain operative only so long as it receives an encrypted “keep alive” command from the serving Call Center. In this optional embodiment, if the Pocket Part does not receive the keep alive signal for a preset period of time, the Pocket Part deactivates and displays only a “Contact Call Center”, or similar message, and requires either entry of a password or receipt of an encrypted “revive” command from a Call Center to be reactivated. An RF resonant tag can be included in the Pocket Part that emits an RF reply when in the vicinity of the proper RF field, much like tag detection systems in retail stores and libraries. RF tag detection can be used at places of mass transit, such as airports and train stations. Detection of a missing Pocket Part by one of the preceding means generates a report to the Pocket Part asset management server and initiates a recovery operation.

Core Services: Call Center Usage and Network Access.

Call Center services and access to private and public networks, particularly the Internet, are normally the core services in most embodiments of the Pocket Concierge service. Call Center services reflect the purpose of the end-user's activities: business, leisure, or a mixture thereof. Local and remote information resources are made available to a Call Center over the Networks to support the Pocket Concierge services provided to end-users. One business embodiment of the Pocket Concierge service is tailored to sales of financial services, such as insurance, investments, and banking. In this financial services embodiment, for example, graphic and tabular illustrations of insurance, investment performance, and banking services are delivered to the Pocket Part based on real-time inquiries from a salesperson meeting with prospects or clients. A subject matter expert, normally at a Call Center, can be videoconferenced or audioconferenced into the meeting as needed using the Pocket Part. A videoconferee or audioconferee can be at the serving Call Center, or at a remote Call Center and connected over a Network to the serving Call Center and the end-user.

Use of the Pocket Concierge service is particularly effective in international business applications, since it enables a central repository of product information and helpdesk experts to be maintained by a company, in the languages of the company's markets, and distributed just-in-time as requested by end-users with Pocket Parts in various countries. In such applications, fiberoptic segments, and optionally satellite services segments, of the Network are used to connect a Call Center in the company's home country with Pocket Concierge service operators in foreign markets. If fiberoptic Network service is used, given the low latency of uncongested fiberoptic transmission, the Call Center and Network server response time is not perceptibly longer in a foreign country than in the company's home country. If the Internet is used as a segment of the Network, congestion is more likely and can lengthen response times. With Call Center personnel skilled in both the relevant foreign language and in the company's products and services, such Call Center personnel can take the lead in presentations if a representative of the company in the foreign country is not highly trained and/or is not fluent in the foreign language. By participating in such presentations, and in tele-training programs delivered through the Pocket Concierge service, personnel can be trained without shuttling training personnel around the world. Pocket Concierge service can be used in communities, such as tele-education programs for schools and universities, to provide guest lecturers from a Call Center or other Networked location, or to provide a full course or curriculum. Where an enterprise owns full-period rights to the use of the Networks and Pocket Parts, or subsidizes their use, tele-education, disaster relief, and other humanitarian activities can be provided as a community service, enhance a company's image, and assist in recruitment. The Pocket Concierge service can provide a “follow me service”, so that voice, fax, video, and data calls are received at an enduser's various network addresses (including telephone numbers), the payload of such calls converted into packets using methods known in the art, and forwarded to the end-user's Pocket Part. The Pocket Part has all the functionality of a mobile phone, including registration on a home or a roaming wireless network when powered up, which enables messages to reach the end-user when the end-user is roaming.

At least one embodiment of the Pocket Concierge is tailored to the travel industry, especially for use by visitors to a foreign country who do not speak the language of the country being visited. As an example, many Japanese visitors to the U.S. would like to experience more than being a member of a tour group, but do not have the fluency or literacy in English to travel comfortably solo or in small groups. In one travel industry embodiment of the Pocket Concierge service, a Japanese-speaking visitor would rent a Pocket Part with a Japanese language user interface. When the end-user visitor had a question about the availability of services or goods (e.g., accommodations, transportation, entertainment, dining, sightseeing, retail goods, vendors, and other items of information), the end-user would place a voice call to the serving Call Center just as any end-user would, as follows: the end-user mounts an earset plugged into the Pocket Part and presses the appropriate button, soft button (labeled area), or hyperlinked text on the touch sensitive LCD screen of the Pocket Part, such button or hyperlinked text is programmed to call the serving Call Center (in this example, a Japanese speaking “seat” (workstation and operator) at the serving Call Center or at a remote Call Center, depending upon the language profile entered for the calling Pocket Part or selected by the end-user). The Call Center agent answers the call and provides the requested information. As required, the Call Center agent could identify and access a network resource (database or application server, etc.) or conference in a human, or software agent, subject matter expert. The call from the end-user might be audio only, or it might include video of the Call Center agent (and others) involved in answering the call. The agent answering the call can be a software agent instead of a human. If video is used, the agent could be an animation, either life-like or cartoon-like, selectable by the end-user. To reduce transmission capacity, the graphic elements, lip motion rules, and body motion rules of the animation could be embedded in the firmware of the Pocket Part. Commands from the relevant Call Center would control the execution of the graphic elements and rules for display on the Pocket Part, which saves wireless bandwidth. Animations could be superimposed on a map to guide the end-user in navigating to a destination. Instead of a voice call, the end-user could prepare a written inquiry (email) and send the email to a Call Center using a data call. Each type of service . . . human operator interaction, software agent interaction, or email interaction . . . could have a different service charge or be accounted for separately by tier of service purchased. A certain amount of data calling (by number, packet, or transmission time) and voice calling is normally included in the basic Pocket Concierge service tier, but amounts in excess of a threshold incur surcharges. Normally included in higher tiers of Pocket Concierge service are specified amounts of Internet access (for Web surfing, email, etc.), games, entertainment, and other information services; amounts in excess of a tier threshold incur surcharges. The Pocket Part can be used as an office, meeting room, airline cabin passenger, airline lounge, or hotel guest room information appliance, especially in conjunction with a an optional video output and external video display (e.g., LCD panel).

The reply from a Call Center to an end-user inquiry involving the location of goods or services normally provides (i) maps to the end-user that display on the Pocket Part, together with the end-user's current location, and (ii) exact directions on how the end-user should proceed to reach a given destination. The display maps and end-user location are updated as the end-user walks, rides, drives, etc. The maps, directions, and other display contents are in the native language of the end-user (Japanese in the example), and can also be bi-lingual (in both the enduser's language and the local language in the visited country), to facilitate asking bystanders for assistance. Display of two or more languages is selectable by the end-user. The functional details of the use of a Pocket Part described in the preceding travel industry embodiment are equally applicable to other end-user segments (e.g., sales force automation, engineering, construction, medical, manufacturing, legal, etc.).

The Pocket Concierge service operator may elect to selectively block voice over Internet calls to require end-users to pay separately for interstate and international calling. Local calling is normally an included service, with amounts varying by tier. Network access, including Internet access, can be measured by time or packets. An optional reward system linked to the purchase of goods or services, performance in games, or contest results, using the Pocket Concierge service generates usage credits to offset surcharges for Internet access, long distance calling, or other services in excess of the amounts included in a pre-purchased tier.

An optional digital camera in the Pocket Part can be used for videoconferencing, and can also store digital photos either in memory in the Pocket Computer, or by transmission from Pocket Part to a storage server. Such transmission can be by airlink, proximate area network, or by docking the Pocket Part in a wired network.

Direct Sales, Advertising Fees, and Commissions.

Pocket Concierge service operator revenue comes not only from basic service fees to end-users (or to intermediaries, who in turn provide the Pocket Parts to end-users), but from direct sales of goods and services, from advertising fees, and from commissions from online, and off-line coupon-based, sales to endusers by participating merchants. Coupons can be bundled with merchants' advertisements, or can be distributed without a related advertisement. Coupons can be paper based or electronic. Electronic coupons are normally redeemed by transmission by the proximate area network in the Pocket Part to a receiver at a point of sale. Based on the subject matter of the inquiry from an end-user, advertisements related to inquiry subject matter could be displayed on the Pocket Part. The advertisements could be coupled with coupons, and the coupons could be time sensitive electronic coupons, that is, the coupons must be redeemed with a limited period. Moreover, the mere proximity of a Pocket Part, based on the detection of a proximate area network “announcement” transmission from the Pocket Part by nearby proximate area network receivers, could trigger the transmission of advertisements and/or coupons to the Pocket Part. The Pocket Part announcement message normally discloses the preferences of the end-user, but usually not his or her identity. User information (i.e., the Pocket Part profile) is normally entered into the memory of a Pocket Part when the Pocket Part is initialized for a new end-user, and can be modified thereafter by a Call Center during a call or, optionally, by the end-user alone. The end-user preferences normally include shopping or procurement information such as the items, types of items, discount levels, quantities, etc., the end-user seeks. Software in the Pocket Computer can negotiate with software agents maintained by merchants and present an offer to the end-user on the display of the Pocket Part in the end-user's language as the end-user passes a merchant's point of offer. (A point of offer is where product or service information is available but a sale cannot be transacted; for instance, there may be no inventory of goods at a point of offer and a purchaser may wish to inspect the goods before purchase. A point of sale is where goods are sold and can be delivered. A point of offer can connect an end-user to a point of sale.) The proximate area network “arrival announcement” and point of offer reply also has application in trade shows and commerce courts. If the location of the point of sale is not obvious, a Call Center can provide directions from the point of offer to the point of sale; providing a map and navigation service normally incurs a fee paid by the merchant to the Pocket Concierge service operator, since the service operator has control over the display of maps and navigation on the Pocket Part. Alternatively, merchants could provide text directions from point of offer to point of sale as part of the exchange of messages over the proximate area network. A credit card swipe reader, stored value means, smart card, smart media, etc., can be built into the Pocket Computer component of the Pocket Part to facilitate sales transactions and data entry.

Under the terms of use of the Pocket Part, the Pocket Concierge service operator normally reserves the right to display advertising on the Pocket Part. The end-user can be offered a reduced Pocket Part rental rate in exchange for viewing, or viewing and responding to, a threshold number of advertisements. Possible responses include a purchase, participation in a market research survey, referral of a prospect, or other acts by the end-user. Alternatively, the terms of service can be that no advertisements, coupons, or promotional messages are permitted unless certain conditions are met, as determined by the Pocket Concierge service agreement with the end-user. Setup of the Pocket Part to block or selectively permit advertisements and coupons normally increases the price to the end-user of each tier of service, since advertising revenue otherwise paid to the Pocket Concierge service operator decreases the price to the end-user of each tier of service. In a third approach to promotional messages delivered to a Pocket Part, the end-user's high credit rating, purchasing authority, or other qualification criteria are validated, and such end-user's Pocket Part would require payment to the end-user's stored value account in the Pocket Part, shipment of a sample, or some other consideration in the end-user's favor, to enable the receipt of an advertisement, coupon, or other promotional message in the end-user's Pocket Part; receipt of such a message can also trigger a payment by the merchant to the Pocket Concierge service operator for providing a qualified prospect. Non-electronic coupons, vouchers, or tickets related to the advertisements or purchases could be printed at printing stations provided by the Pocket Concierge operator, at any printer with a infrared or proximate area network interface, or forwarded to the address (hotel, business, or home) of the end-user.

Promotional messages delivered to a Pocket Part can be multimedia. Additional sales information, documentation, etc., especially in the case of technical or costly items, could be sent to the end-user's attention at a Network address for later retrieval by the end-user. The type of promotional message reflects the specific transaction. In a leisure market application, a tourist can be shown video on the Pocket Part of a restaurant interior, entrees, entertainers, etc., to solicit a reservation or walk-in visit. In a business market application, a purchasing manager can be shown the product, installation methods, testimonials by respected experts, customizations, etc.

Payment for purchases made by an end-user using a Pocket Part can be made electronically and transmitted over the proximate area network, e.g., by debiting a stored value account in the Pocket Part (the electronic equivalent of a cash sale), or by debit card, credit card, or charge card. Such electronic payments would normally be encrypted or made secure by other techniques known in the art. Alternatively, the end-user could make a physical payment, but would be rewarded for reporting to the Pocket Concierge service operator physical payments (e.g., the reward could be offsets against surcharges), which would enable the service operator to collect a sales commission from the merchant based on a sales receipt number or equivalent.

Sales of goods and services marketed by the Pocket Concierge operator (direct sales) would generate direct sales revenue for the Pocket Concierge operator. Sales of goods and services by a third party advertiser would generate commission revenue for the Pocket Concierge operator. When a purchase is made interactively in response to a third party's advertisement on the Pocket Part, or by use of a coupon, the Pocket Concierge service operator earns a commission on the sale as negotiated by the Pocket Concierge service operator and the advertiser or merchant. The use of the Pocket Concierge service could be free to an end-user if a threshold amount of purchases are made; as discussed above, purchases could also generate credits that offset usage surcharges.

Transaction Histories and Follow-on Marketing.

Subject to information privacy laws or to contracts between the Pocket Concierge service operator and end-users, the history of transactions entered into by the end-user can be used for later marketing campaigns directed to end-users, for instance, to offer replenishment of consumables, upgrades, or replacements of items purchased by the end-user. For negotiations that did not lead to sales, merchants could send follow-up offers. For anonymous sales and for negotiations that did not lead to sales, the identity of the end-user can be shielded from the merchant by a screening service provided by the Pocket Concierge service operator. Whether the transaction history information is used for follow-on marketing purposes or not, the operator of the Pocket Concierge service normally retains that end-user's account information online. In the event such end-user again subscribes to Pocket Concierge service, the transaction history and preferences can be updated and used to extend suggestions and promotional messages to the end-user.

Service Tiers and Fee-based Upgrades.

For leisure market segments, such as the travel industry, specified combinations and amounts (by time or packet) of: Call Center usage, Internet access, entertainment (e.g., live television and radio from the end-user's country or from other countries using an MPEG 4 or equivalent bitcasting feed or other digital compression technology), prerecorded programming, single player or multiplayer games, local, interstate and international voice calling, video calling between Pocket Parts, specialized database or application server access, and other information services are aggregated into various “tiers” of Pocket Concierge service.

For company employees in business market segments, Pocket Concierge service tiers normally reflect job responsibilities and network privileges. A company can operate its own Pocket Concierge service as an extension of an existing helpdesk, can outsource the management of Pocket Parts and wireless services to an outsourcing provider to supplement an existing helpdesk, or can outsource the entire Pocket Concierge service operation. The Pocket Concierge service can be very effective in strengthening and expanding supply chains and distribution channels. In supply chain and project team usage, key personnel at suppliers to, or joint venturers with, a company access the company's intranet and internal phone system using the Pocket Concierge service using directories loaded in the Pocket Part or accessible by the Pocket Part. In distribution channel management, sales representatives (e.g., detail persons for a pharmaceutical manufacturer) use the Pocket Concierge service to answer prospect and customer questions while meeting with such prospects and customers, or during Q&A sessions at larger meetings. During such meetings, the optional audio and video external output from the Pocket Part can be fed to a sound systems, monitor, or videoprojector for group viewing.

Additional amounts of information services can be purchased as an upgrade package or on an a la carte basis to supplement the service amounts provided in the various tiers of Pocket Concierge service. Such additional services could include access to fee-based database and application servers operated by third parties, e.g., econometrics, investment analytics, just-in-time training, etc.; such sales would generate commission revenue for the Pocket Concierge service operator. Constant improvements in information technology have accelerated the adoption of lifelong learning. Just-in-time training delivered over a Pocket Part provides a new, cost-effective method to deliver such training, especially when the subject matter involves locations where traditional multimedia computers or interactive audiovisual devices are inconvenient, such as mobile work, outdoor work, or education and training in areas with poor wireline communications infrastructure.

Peripheral Rental; ad hoc Videoconferencing.

Pocket Parts can be equipped with interfaces to support external displays, external digital cameras, printers, amplifiers and loudspeakers, microphones, external sensors, and other types of peripherals and instrumentation. The Pocket Concierge service operator can rent such peripherals to end-users. In particular, as Pocket Concierge services became available in more cities, a Pocket Part, videoprojector, sound system, and external camera could provide a cost effective method of ad hoc videoconferencing. Tele-medicine offers many opportunities for ad hoc videoconferencing and telemetry, especially for emergency medicine and disaster relief. A Pocket Part can be used to permit medical staff at or networked with a Call Center to participate in delivering medical services at the scene of an accident or natural disaster. A Pocket Part used with air or water navigation services can assist aviators and sailors in distress. Emergency medicine use of a Pocket Part normally involves data transmission of vital signs of injured persons and high datarate videoconferencing (since accurate color information and high resolution are important in medical diagnoses). Consequently, Pocket Parts designed for use by emergency medical teams, law enforcement officers, and fire engine crews normally include better quality video and audio components.

Maintenance.

Wide distribution, especially on an international scale, of traditional computers normally creates major maintenance problems and expenses. Troubleshooting problems with high technology equipment often requires skills that may not be available in foreign countries. Pocket Parts are small enough to send by air express services back to central maintenance depots for maintenance and hardware upgrades. Software upgrades of Pocket Parts are normally handled by flash upgrades of firmware, even while Pocket Parts are in the field. Moreover, the small size of the Pocket Parts makes maintaining a large inventory of devices very easy. If a Pocket Part unit fails, a replacement unit is delivered to the end-user or swapped at a service counter.

I claim:

1. An method of providing information services, comprising:
using a Pocket Part with a Wireless Module to communicate with a Call Center and a Network to obtain multimedia information services.

1. An system comprising:
a Pocket Part with a Wireless Module in wireless communications with a Call Center and a Network to obtain multimedia information services.
